(19) United States
(12) Patent Application Publication
(10) Pub. No.: US 2026/0288973 A1
(43) Pub. Date: Sep. 24, 2026

(54) INFORMATION PROCESSING DEVICE, METHOD, AND STORAGE MEDIUM

(71) Applicant: KABUSHIKI KAISHA TOSHIBA, Kawasaki-shi Kanagawa (JP)

(72) Inventors: Ryuiti KOIKE, Kawasaki Kanagawa (JP); Tatsuya UEHARA, Kawasaki Kanagawa (JP); Hiroho WADA, Yokohama Kanagawa (JP); Jun KANAI, Inagi Tokyo (JP)

(73) Assignee: KABUSHIKI KAISHA TOSHIBA, Kawasaki-shi Kanagawa (JP)

(21) Appl. No.: 19/546,843

(22) Filed: Feb. 23, 2026

(30) Foreign Application Priority Data
Mar. 19, 2025 (JP) 2025-044376

(51) Int. Cl. G06F 21/57

(52) U.S. Cl. CPC G06F 21/577

(57) ABSTRACT

According to one embodiment, an information processing device stores vulnerability information groups, each of which includes disclosed vulnerabilities, one or more components, and a degree of risk associated respectively, acquires the vulnerability information groups, compares the degree of risk with predetermined thresholds for each of a plurality of pieces of target vulnerability information related to the components constituting a target device, issues an alert when the degree of risk exceeds the thresholds for the first time, aggregates the number of alerts issued within the designated period for each of the thresholds, and recommends one of the thresholds satisfies a standard set by the user.

### CROSS-REFERENCE TO RELATED APPLICATIONS

This application is based upon and claims the benefit of priority from Japanese Patent Application No. 2025-044376, filed Mar. 19, 2025, the entire contents of which are incorporated herein by reference.

### FIELD

Embodiments described herein relate generally to an information processing device, a method, and a storage medium.

### BACKGROUND

In recent years, devices connected to the Internet have rapidly become widespread. Under such circumstances, vulnerability of software included in a device (security weakness in software) is attacked by a malicious third party, and serious problems including financial damage frequently occur. In order to prevent these attacks, it is necessary to constantly monitor vulnerability of components constituting the device and continuously perform appropriate correction according to a degree of risk thereof. Examples of the degree of risk are a degree of severity and a degree of threat.

However, for all the vulnerabilities that are found in large numbers, it is costly for humans to continue to determine their degrees of risk. Therefore, there is a demand for realistic and efficient operation in which the handling priority of vulnerability assumed to have a high degree of risk is raised to be preferentially determined and handled by humans, whereas handling priorities of vulnerability assumed to have other degrees of risk are lowered.

As one of the above-described operation, for example, vulnerability handling is known. In the vulnerability handling, for example, a vulnerability of components of each device is recognized, the degree of risk of the vulnerability is determined. When the degree of risk of the vulnerability is high, an alert is issued to notify a developer of vulnerability information. However, an optimal vulnerability handling operation varies depending on the device, the business in which the device is used, and the like. The optimal vulnerability handling operation is, for example, alert occurrence frequency, alert accuracy, and the like. For this reason, particularly when a new device is introduced, it is difficult to perform the vulnerability handling suitable for the device.

### BRIEF DESCRIPTION OF THE DRAWINGS

FIG. 1 is a diagram illustrating a configuration example of an in-house system including a vulnerability handling simulation device according to a first embodiment.

FIG. 2 is a diagram illustrating an example of a hardware configuration of the vulnerability handling simulation device according to the first embodiment.

FIG. 3 is a diagram illustrating a configuration example of a component information table in the first embodiment.

FIG. 4 is a diagram illustrating a configuration example of a vulnerability information group table in the first embodiment.

FIG. 5 is a diagram illustrating a configuration example of a vulnerability information table in the first embodiment.

FIG. 6 is a diagram illustrating a configuration example of a correct answer information table in the first embodiment.

FIG. 7 is a diagram illustrating an example of a risk threshold recommendation screen in the first embodiment.

FIG. 8 is a diagram illustrating a detailed configuration example of the vulnerability handling simulation device according to the first embodiment.

FIG. 9 is a flowchart illustrating a flow of entire processing executed by the vulnerability handling simulation device according to the first embodiment.

FIG. 10 is a flowchart illustrating an example of a flow of vulnerability handling simulation processing in the first embodiment.

FIG. 11 is a diagram illustrating an example of an alert information table in the first embodiment.

FIG. 12 is a diagram for explaining an alert occurrence timing in the first embodiment.

FIG. 13 is a conceptual diagram illustrating four quadrants allocated by a correct answer alert determination module in the first embodiment.

FIG. 14 is a diagram illustrating a configuration example of a vulnerability handling simulation device according to a second embodiment.

FIG. 15 is a conceptual diagram for explaining prediction of version information by a component version prediction module in the second embodiment.

### DETAILED DESCRIPTION

In general, according to one embodiment, an information processing device is provided. The information processing device includes a time-series vulnerability information storage, a past alert determination module, and an operational rule recommendation module. The time-series vulnerability information storage stores vulnerability information groups, each of which is stored at predetermined time intervals and includes a plurality of pieces of vulnerability information, each of the pieces of vulnerability information having a disclosed vulnerability, one or more components related to the vulnerability, and a degree of risk of the vulnerability associated respectively. The past alert determination module sequentially acquires the vulnerability information groups stored within a period designated by a user, compares the degree of risk with predetermined thresholds for each of a plurality of pieces of target vulnerability information related to components constituting a target device among the pieces of vulnerability information included in the acquired vulnerability information groups, and issues an alert when the degree of risk exceeds the thresholds for the first time within the designated period. The operational rule recommendation module aggregates the number of alerts issued within the designated period for each of the thresholds, and recommends, as a threshold for issuing an alert related to vulnerability of the target device, one of the thresholds at which an index related to the number of alerts satisfies a standard set by the user.

Hereinafter, each embodiment will be described with reference to the drawings.

Note that the disclosure is merely an example, and the invention is not limited by the contents described in the following embodiments. Modifications of which a person skilled in the art may easily conceive are naturally included in the scope of the disclosure. In order to make the description clearer, the size, shape, and the like of each part may be schematically represented by being changed from those of the actual embodiment in the drawings. In a plurality of drawings, corresponding elements are denoted by the same reference numerals, and a detailed description thereof may be omitted.

Software running on each device often includes some vulnerability. In a system operated for a long time, there is a high possibility that a vulnerability is found in software constituting a product device in the system at any time during operation, and the software is abused by an attacker. For this reason, in general, in a case where a vulnerability is found, the operation of the system is continued while the software is being corrected with a patch.

In order to find the vulnerability of the device as described above, for example, a vulnerability management system is used. The vulnerability management system stores, for example, information of software constituting each product device. The vulnerability management system issues an alert in a case where a vulnerability is found in these components, thereby notifying a manager or a developer of the information related to the vulnerability.

When the vulnerability management system issues an alert, a human such as the manager examines the degree of risk (vulnerability risk) and determines whether or not correction such as patch application should be performed. Specifically, the manager checks the content of the vulnerability notified by the alert, and determines to perform patch application if the degree of risk of the vulnerability is high. The manager determines to continue operation without performing patch application if the degree of risk is acceptable. Note that examples of the degree of risk include the Common Vulnerability Scoring System (CVSS) and the Exploit Prediction Scoring System (EPSS). As described above, in a case where an alert occurs, it is necessary to finally perform review and determination by a human, and a work cost associated therewith occurs. Therefore, it is important to reduce the number itself of alerts in actual operation.

As an operation for reducing the number of alerts, for example, vulnerability handling is known. The vulnerability handling is a series of processing of recognizing vulnerability of components of a device, determining a degree of risk of the vulnerability, and determining a necessity of an alert according to the degree of risk. For example, the number of alerts can be reduced by operating the vulnerability handling so as not to issue an alert when the determined degree of risk of vulnerability is equal to or less than a preset risk threshold.

However, it is difficult to set an appropriate value for the risk threshold in advance because the appropriate value for the risk threshold is a different value for each device or business. Setting a strict risk threshold leads to overlooking of an important alert, whereas setting a loose risk threshold generates a large number of alerts and increases human review costs. That is, although the developer or the manager of the device desires to operate the vulnerability management system with an alert frequency and accuracy assumed in advance, there is currently no method for appropriately determining the risk threshold for that purpose.

The vulnerability handling simulation device according to the present embodiment has been made in view of the above-described problems, and is a device configured to recommend an appropriate vulnerability handling operation (for example, a risk threshold that is an optimal alert occurrence frequency, alert accuracy, and the like.) for each device.

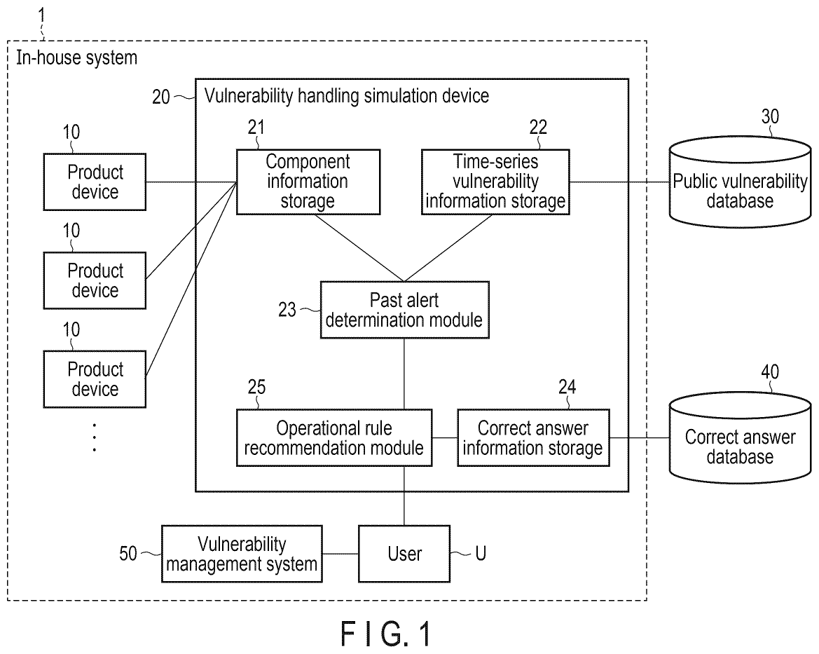

FIG. 1 is a diagram illustrating a configuration example of an in-house system 1 including a vulnerability handling simulation device 20 according to a first embodiment.

The in-house system 1 is, for example, a system provided for performing a predetermined business. The in-house system 1 includes, for example, product devices 10, a vulnerability handling simulation device 20, and a vulnerability management system 50. In addition, the vulnerability handling simulation device 20 in the in-house system 1 can access a public vulnerability database 30 and a correct answer database 40 via the Internet.

The product devices 10 are, for example, an embedded device before shipment or a personal computer (PC). Each of the product devices 10 includes software configured to implement various functions. Note that there are various variations of the product devices 10, and a combination of software configuring each of the product devices 10 is different for each of the product devices 10. In the following description, each piece of software configuring each of the product devices 10 may be referred to as a “component”.

The public vulnerability database 30 is a database that accumulates information of vulnerability related to software in the world that is found every day. The public vulnerability database 30 is disclosed on the Internet and can be confirmed by anyone.

An example of the public vulnerability database 30 is the National Vulnerability Database (NVD). In the NVD, a pair of a vulnerability number assigned to a vulnerability and a component (including the vulnerability) associated with the vulnerability is disclosed. According to the public vulnerability database 30, it is possible to detect the vulnerability of each of the product devices 10 by referring to the vulnerability associated with the component of each of the product devices 10. In addition, in the NVD, a quantitative numerical value of risk of the vulnerability (that is, a degree of risk) is disclosed. Note that the public vulnerability database 30 may include, for example, various databases other than the NVD.

The correct answer database 40 is a database listing vulnerabilities that mean high possibility of abuse (degree of risk) and are preferably corrected without being left. The correct answer database 40 accumulates, for example, a list of attention-seeking vulnerabilities published by an authorized agency or a list of public attack codes.

An example of the list of attention-seeking vulnerabilities published by an authorized agency is Known Exploited Vulnerabilities Catalog (KEV Catalog) of Certified Information Systems Auditor (CISA) (registered trademark). The vulnerability included in the KEV Catalog is a vulnerability that has been confirmed to be exploited in the world, and can be said to be a vulnerability that means high possibility of attack (imminent attack). That is, the vulnerability included in the KEV Catalog is a vulnerability with a high degree of threat that needs to be corrected.

An example of the list of public attack codes is Exploit-DB. An attack code disclosed in the exploit database (Exploit-DB) is an attack code for attacking a vulnerability. That is, the vulnerability to be attacked by the attack code disclosed in the Exploit-DB is a vulnerability that is easy to attack and has a high degree of risk.

The vulnerability handling simulation device 20 is a device that simulates vulnerability handling for each of the product devices 10. Hereinafter, among the product devices 10, a product device to be simulated for vulnerability handling may be referred to as a “target product device 10”.

The vulnerability handling simulation device 20 always operates as a server, and repeats processing of acquiring vulnerability information from outside the company (the public vulnerability database 30 and the correct answer database 40) and storing the vulnerability information internally. The vulnerability handling simulation device 20 includes, for example, a component information storage 21, a time-series vulnerability information storage 22, a past alert determination module 23, a correct answer storage 24, and an operational rule recommendation module 25.

The component information storage 21 stores, for each of the product devices 10, a plurality of pieces of component information in which the product device 10, one or more components constituting the product device 10, and the simulation start date for the product device 10 are associated with each other. The “simulation start date” is a date that is the first day of a period of simulating vulnerability handling when the vulnerability handling is simulated for the product device 10. The plurality of components and the simulation start dates may be input by a user U or may be acquired from each of the product devices 10.

The time-series vulnerability information storage 22 is a storage medium that stores a plurality of pieces of vulnerability information in which a vulnerability disclosed in the public vulnerability database 30, one or more components related to the vulnerability, and a degree of risk of the vulnerability are associated with each other. The plurality of pieces of vulnerability information is stored such that a plurality of pieces of vulnerability information found in one day is collected for each date, and a plurality of pieces of vulnerability information corresponding to an arbitrary date can be extracted. Hereinafter, a plurality of pieces of vulnerability information corresponding to an arbitrary day is referred to as a “vulnerability information group”.

While the vulnerability information disclosed in the public vulnerability database 30 discloses the latest information at that time, the past information is often overwritten and the content cannot be retrieved. Therefore, as described above, by storing the vulnerability information found in one day each time, it is possible to extract vulnerability information of an arbitrary date from the time-series vulnerability information storage 22. Note that, since the storage capacity increases if the daily vulnerability information is continuously stored as it is, the time-series vulnerability information storage 22 may store a difference from the previous day as a physical arrangement of information on the storage.

The past alert determination module 23 issues a pseudo alert related to vulnerability of the component of the target product device 10 within a period designated by the user U based on the vulnerability information groups stored within the period designated by the user U. Specifically, the past alert determination module 23 sequentially acquires the plurality of vulnerability information groups stored within a period designated by the user U. Then, the past alert determination module 23 compares a degree of risk with predetermined risk thresholds for each of a plurality of pieces of vulnerability information related to components constituting the target product device 10 among a plurality of pieces of vulnerability information included in the acquired vulnerability information group. In other words, while changing the risk threshold, the past alert determination module 23 compares the degrees of risk with the risk threshold. The past alert determination module 23 issues an alert when the degree of risk exceeds the risk threshold for the first time within the period designated by the user U. Hereinafter, the plurality of pieces of vulnerability information related to the components constituting the target product device 10 will be referred to as “target vulnerability information”. In addition, the period designated by the user U is referred to as a “simulation period”.

The correct answer storage 24 stores a plurality of pieces of correct answer information disclosed in the correct answer database 40.

The operational rule recommendation module 25 recommends a risk threshold suitable for issuing an alert related to the vulnerability of the target product device 10 based on alert occurrence frequency and alert accuracy by the past alert determination module 23.

Specifically, the operational rule recommendation module 25 aggregates the number of alerts issued within the simulation period for each of the plurality of risk thresholds. In addition, the operational rule recommendation module 25 aggregates, for each of the plurality of risk thresholds, the number of times that the vulnerability information for which the alert is issued matches the correct answer information among the number of the alert occurrence. Hereinafter, vulnerability information related to a vulnerability that is highly likely to be exploited and is desirably corrected without being left unattended will be referred to as “correct answer information”. The correct answer information is a vulnerability information for an alert should be issued. In addition, among the number of times of alert issuance, the number of times that the vulnerability information for which the alert is issued is matched with the correct answer information is referred to as “the number of correct answers”.

Then, the operational rule recommendation module 25 recommends, as a risk threshold for issuing an alert related to the vulnerability of the target product device 10, a risk threshold at which the index regarding the number of alerts and the index related to the number of correct answers further satisfy the criteria defined by the user U. The index regarding the number of alerts is, for example, a frequency of alerts at predetermined interval. The example of the predetermined interval is one month. The index related to the number of correct answers is, for example, a matching rate and a coverage. The matching rate and the coverage will be described later.

Specifically, the operational rule recommendation module 25 recommends the risk threshold by displaying it on a monitor (not illustrated) connected to the vulnerability handling simulation device 20 or the vulnerability management system 50. Alternatively, the operational rule recommendation module 25 may recommend the risk threshold by transmitting it to the vulnerability management system 50 and setting it as a risk threshold in actual operation of vulnerability handling of the target product device 10.

The vulnerability management system 50 is a system that finds vulnerabilities of the product devices 10 and issues a vulnerability alert. In the vulnerability management system 50, for example, the risk threshold recommended by the vulnerability handling simulation device 20 is set as a condition for issuing the vulnerability alert. The risk threshold may be set directly from the vulnerability handling simulation device 20 or may be set to a value input by the user U.

Note that, although FIG. 1 illustrates a mode in which the vulnerability handling simulation device 20 and the vulnerability management system 50 are separated, the vulnerability handling simulation device 20 may be incorporated as one function of the vulnerability management system 50, or the vulnerability management system 50 may be incorporated as one function of the vulnerability handling simulation device 20. Some or all of functions of the vulnerability handling simulation device 20 and the vulnerability management system 50 may be implemented by a cloud server.

The user U is a user who uses the vulnerability handling simulation device 20 and the vulnerability management system 50. The user U includes, for example, a manager who manages the vulnerability handling simulation device 20 and the in-house system 1.

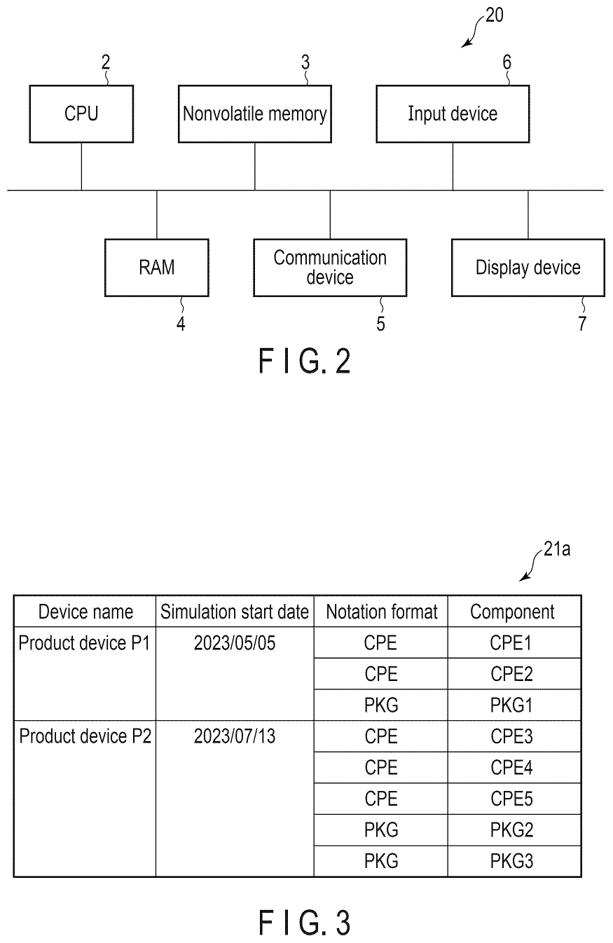

FIG. 2 is a diagram illustrating an example of a hardware configuration of the vulnerability handling simulation device 20 according to the first embodiment.

The vulnerability handling simulation device 20 includes, for example, a central processing unit (CPU) 2, a nonvolatile memory 3, a random access memory (RAM) 4, a communication device 5, an input device 6, a display device 7, and the like.

The CPU 2 is a processor configured to control the operation of the vulnerability handling simulation device 20. The CPU 2 is at least one processor. The CPU 2 executes various programs loaded from the nonvolatile memory 3 to the RAM 4. These programs include an operating system (OS), an application program configured to simulate vulnerability handling, and the like.

The nonvolatile memory 3 is a storage medium used as an auxiliary storage device. The nonvolatile memory 3 can be used as a storage area for various types of information used by the vulnerability handling simulation device 20. Although only the nonvolatile memory 3 is illustrated in FIG. 2, the vulnerability handling simulation device 20 may include other storage devices such as a hard disk drive (HDD) and a solid state drive (SSD).

The RAM 4 is a storage medium used as a main storage device. The RAM 4 can be used as a temporary storage area of data used for processing by the vulnerability handling simulation device 20.

The communication device 5 is a device configured to execute wireless communication for acquiring various types of information from the product devices 10, the public vulnerability database 30, the correct answer database 40, and the like.

The input device 6 is a device configured for the user U to input various types of information to the vulnerability handling simulation device 20.

The display device 7 is, for example, a monitor, and is a device configured to display a screen indicating a result (recommended risk threshold) of the vulnerability handling simulation by the vulnerability handling simulation device 20.

Note that some or all of the past alert determination module 23 and the operational rule recommendation module 25 illustrated in FIG. 1 are achieved by causing the CPU 2 to execute a predetermined program, that is, by software. This program may be stored in a computer-readable storage medium and distributed, or may be downloaded to the vulnerability handling simulation device 20 through a network. Note that some or all of the past alert determination module 23 and the operational rule recommendation module 25 may be implemented by dedicated hardware or the like, or may be implemented by a combination of software and hardware.

In addition, the component information storage 21, the time-series vulnerability information storage 22, and the correct answer storage 24 illustrated in FIG. 1 are implemented by, for example, the nonvolatile memory 3 or another storage device.

FIG. 3 is a diagram illustrating a configuration example of component information table 21a stored in the component information storage 21. The component information table 21a is a table for managing one or more pieces of component information corresponding to each of the product devices 10.

The component information table 21a includes, for example, a plurality of entries respectively corresponding to the product devices 10. Each of the plurality of entries includes, for example, a “device name” field, a “simulation start date” field, a “notation format” field, and a “component” field.

In the entry corresponding to a certain product device 10, the “device name” field indicates the name of the product device 10.

The “simulation start date” field indicates a simulation start date when vulnerability handling is simulated for the product device 10. For example, in the example of FIG. 3, when vulnerability handling for a product device P1 is simulated, the simulation period is a period from May 5, 2023 set in the “simulation start date” field to the current date. The simulation start date is input by the user U when the product device 10 is introduced into the in-house system 1 and connected to the vulnerability handling simulation device 20. Alternatively, the same simulation start date may be set for all the product devices 10.

The “notation format” field indicates a notation format of a component constituting the product device 10. The “component” field indicates a component constituting the product device 10.

An example of the notation format of the component is common platform enumeration (CPE). CPE is a notation format that follows the uniform resource identifier (URI) scheme and starts with cpe:/and separates each element with a colon (:). Each element is, for example, type of component, vendor name, product name, version, update, edition, and language.

Specifically, for example, a component described by the CPE is described as “cpe : /type : vendor name : product name : version : update : edition : language : . . . (notation example “cpe : /2.3 : a : apache : http_server : 2.4.53 : * : * : * : * : * : * : *”)”. The “type” indicates hardware (h), OS (O), and application (a). “Vendor name” indicates a creator or a creating group of the component. “Version” and “edition” indicate a number or the like indicating a specific type (version) of the component. “Language” indicates a language of the component. Subsequent elements are also described as necessary, and may be omitted by an asterisk (*) when an arbitrary element follows. In the example of FIG. 3, the components denoted by the CPE are referred to as CPE1, CPE2. . . .

Another example of the notation format of the component is a package name of a Linux (registered trademark) distribution. The Linux package is a distribution unit in which software and its related files are collected, and is notated as “package name conforming to the distribution-specific naming rule and version conforming to the distribution-specific naming rule (notation example “app_x 1.35”)”. In the example of FIG. 3, components notated by package names of the Linux distribution are denoted as PKG1, PKG2. . . .

That is, in the example of FIG. 3, the product device P1 includes a total of three components: two components (CPE1 and CPE2) notated in the CPE format and one component (PKG1) notated by a package name of the Linux distribution.

When the notation format of the component of the product device 10 is the CPE format, the “notation format” field and the “component” field are determined and input by the user U based on a design document of the product device 10. In addition, when the notation format of the component of the product device 10 is the Linux package name, the “notation format” field and the “component” field are acquired and input from the package management system providing the component of the product device 10 by the vulnerability handling simulation device 20.

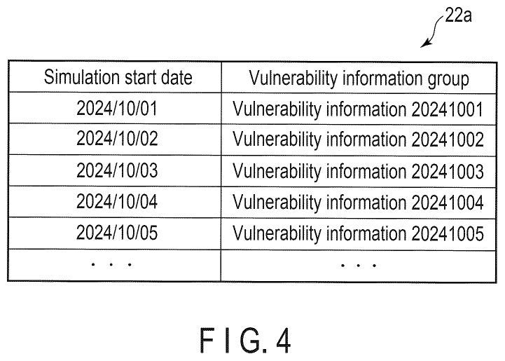

FIG. 4 is a diagram illustrating a configuration example of a vulnerability information group table 22a. The vulnerability information group table 22a is a table for managing vulnerability information groups respectively corresponding to each of dates. The vulnerability information group table 22a is stored in the time-series vulnerability information storage 22.

The vulnerability information group table 22a includes, for example, a plurality of entries respectively corresponding to dates. Each of the plurality of entries includes, for example, a “date” field and a “vulnerability information group” field.

In the entry corresponding to a certain date data, the “date” field indicates the date. FIG. 4 illustrates a case where the vulnerability information group is acquired at daily intervals.

The “vulnerability information group” field indicates the name of a vulnerability information group including a plurality of pieces of vulnerability information acquired on the date. For example, the name of the vulnerability information group acquired on Oct. 1, 2024 is “vulnerability information 20241001”.

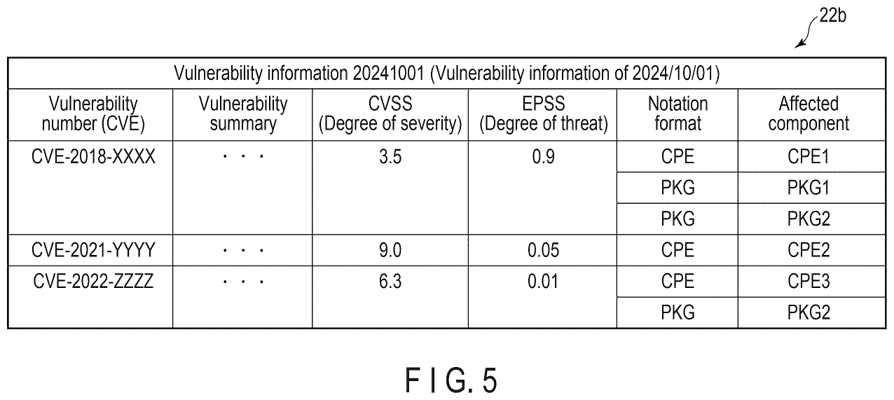

FIG. 5 is a diagram illustrating a configuration example of a vulnerability information table 22b. The vulnerability information table 22b is a table for managing a plurality of pieces of vulnerability information included in a vulnerability information group corresponding to an arbitrary date. In other words, the vulnerability information table 22b is a table for managing the plurality of pieces of vulnerability information acquired on the arbitrary date. The vulnerability information table 22b is stored in the time-series vulnerability information storage 22. Note that FIG. 5 illustrates a plurality of pieces of vulnerability information (vulnerability information 20241001) acquired on Oct. 1, 2024.

The vulnerability information table 22b includes, for example, a plurality of entries respectively corresponding to a plurality of vulnerabilities. Each of the plurality of entries includes, for example, a “vulnerability number (CVE)” field, a “vulnerability summary” field, a “CVSS (degree of severity)” field, an “EPSS (degree of threat)” field, a “notation format” field, and an “affected component” field.

The “vulnerability number (CVE)” field corresponding to certain vulnerability indicates an identifier (common vulnerabilities and exposures (CVE)) assigned to the vulnerability. Hereinafter, the vulnerability with a vulnerability number of X may be simply referred to as “vulnerability X”.

The “vulnerability summary” field indicates an explanatory sentence on the summary of the vulnerability.

The “CVSS (degree of severity)” field indicates a severity of the vulnerability. Here, CVSS is used as an index of a degree of severity of vulnerability. The CVSS is an index indicating an influence of an attack on the vulnerability on an entire system including an attack target, a host, or the like. The CVSS represents a magnitude of a risk at 0 to 10. For example, the degree of severity of the vulnerability number CVE-2018-XXXX is 3.5.

The “EPSS (degree of threat)” field indicates a degree of threat of vulnerability. Here, EPSS is used as an index of the degree of threat of vulnerability. The EPSS is an index indicating a possibility that the vulnerability is abused. The EPSS represents a magnitude of a risk at 0 to 1. For example, the degree of threat of the vulnerability number CVE-2018-XXXX is 0.9.

The “notation format” field indicates a notation format of a component affecting the vulnerability. The notation format is similar to the “notation format” field of the component information table 21a in FIG. 3.

The “affected component” field indicates a component that affects the vulnerability. The component is similar to the “component” field of the component information table 21a in FIG. 3.

Specifically, the vulnerability CVE-2018-XXXX is vulnerability that affects a total of three components: one component (CPE1) denoted in CPE format; and two components (PKG1, PKG2) denoted in the package name of the Linux distribution. Similarly, the vulnerability CVE-2021-YYYY is a vulnerability that affects one component (CPE2) denoted in CPE format. The vulnerability CVE-2022-ZZZZ is a vulnerability that affects one component (CPE3) denoted in CPE format and one component (PKG2) denoted in the package name of the Linux distribution.

Note that, since the notation format of the components differs depending on the type of the public vulnerability database 30 from which the vulnerability information is acquired, for example, CPE1 and PKG1 may essentially refer to the same component. By storing the same component in both the CPE format and the PKG format, it is possible to understand whether or not the component of the target product device 10 is included in the affected component of the vulnerability information table 22b regardless of the notation format in which the component of the target product device 10 is stored.

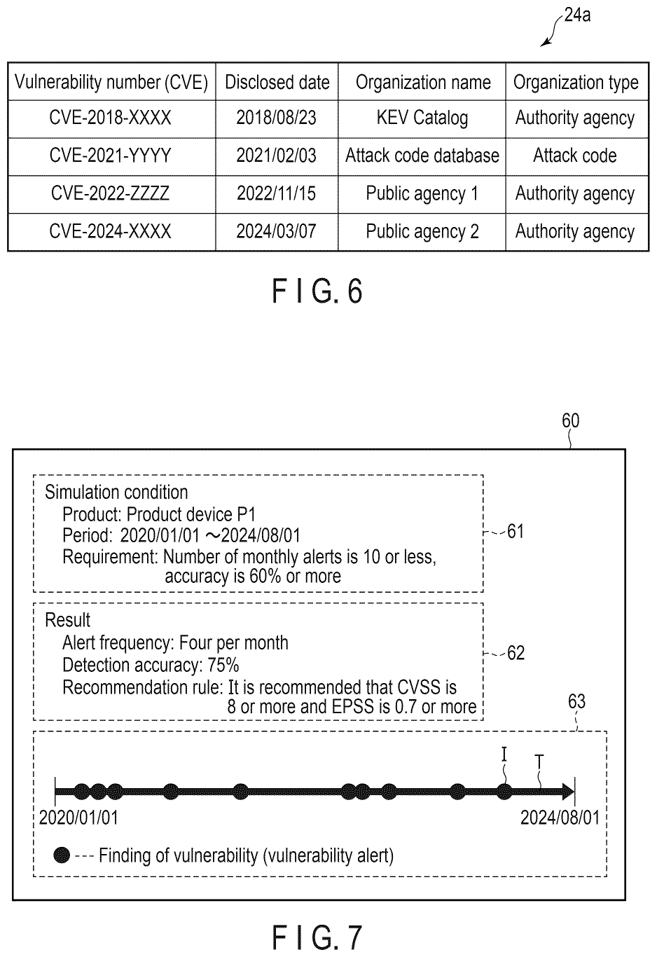

FIG. 6 is a diagram illustrating a configuration example of a correct answer information table 24a. The correct answer information table 40a is a table for managing a plurality of pieces of correct answer information that are highly likely to be misused. The correct answer information table 24a is stored in the correct answer storage 24.

The correct answer information table 24a includes, for example, a plurality of entries respectively corresponding to a plurality of pieces of correct answer information. Each of the plurality of entries includes, for example, a “vulnerability number (CVE)” field, a “disclosure date” field, an “organization name” field, and a “organization type” field.

In the entry corresponding to certain correct answer information, the “vulnerability number (CVE)” field indicates an identifier allocated to the correct answer information. Note that the same identifier is assigned to the same vulnerability as the vulnerability illustrated in FIG. 5.

The “disclosure date” field indicates a date and time when the correct answer information is disclosed.

The “organization name” field indicates a name of an organization that has disclosed (found) the correct answer information.

The “organization type” field indicates a type of an organization that has disclosed the correct answer information. For example, in a case of the correct answer information disclosed by KEV Catalog disclosed from CISA and other public agencies, for example, “authority agency” is set in the “organization type” field. In a case of the correct answer information released by an attack code database such as the Exploit DB, for example, an “attack code” is set in the “organization type” field.

According to the correct answer information table 24a of FIG. 6, for example, it can be seen that CISA, which is an authority agency, has announced attention to CVE-2018-XXXX through the KEV Catalog on Aug. 23, 2018. Similarly, it can be seen that the attack code targeting CVE-2021-YYYY has been disclosed in the attack code database on Feb. 3, 2021. These can be said to be vulnerabilities for which an attack is imminent and an alert should be issued.

FIG. 7 is a diagram illustrating an example of a risk threshold recommendation screen 60 displayed by the operational rule recommendation module 25. The risk threshold recommendation screen 60 is, for example, a screen displayed on a monitor (not illustrated) connected to the vulnerability handling simulation device 20 in order to recommend an operational rule (risk threshold) suitable for the target product device 10 after the vulnerability handling simulation device 20 simulates the vulnerability handling to the target product device 10. Here, a case where an operational rule suitable for the product device P1 is recommended will be exemplified.

The risk threshold recommendation screen 60 includes, for example, a simulation condition display area 61, a simulation result display area 62, and an alert frequency display area 63. The simulation result display area 62 and the alert frequency display area 63 are displayed after the vulnerability handling is simulated under the conditions set in the simulation condition display area 61.

The simulation condition display area 61 displays a simulation condition of vulnerability handling. Conditions for simulating the vulnerability handling are, for example, “product”, “period”, and “requirement”. These conditions are set by the user U when the simulation of the vulnerability handling is started.

The “product” indicates the target product device 10 to be simulated for vulnerability handling. In the example of FIG. 7, it is the product device P1.

The “period” is a period for simulating vulnerability handling. Hereinafter, the period for simulating vulnerability handling referred to as “the simulation period”. The simulation period is a period from a time point at which the component of the target product device 10 (here, the product device P1) is fixed product device P1 to the present. In other words, the simulation period is a period from a time point at which the component is installed in the target product device 10 to the present. Here, the simulation period for the product device P1 is designated the period from Jan. 1, 2020 to Aug. 1, 2024.

The “requirement” indicates the frequency of the alert and the accuracy of the alert desired (allowable) by the user U related to the vulnerability handling for the target product device 10. Hereinafter, the frequency of the alert and the accuracy of the alert desired (allowable) by the user U are referred to as “desired requirement”. Here, as the desired requirement, the frequency of the alert is set to 10 or less per month, and the allowable accuracy of the alert is set to 60% or more. The desired requirement is determined depending on, for example, a budget that can be allocated to respond to the alert.

The simulation result display area 62 displays a result in a case where the risk threshold is set to the risk threshold recommended by the operational rule recommendation module 25 among the results of simulating the vulnerability handling to the target product device 10. The result includes, for example, “alert frequency”, “detection accuracy”, and “recommendation rule”.

The “alert frequency” indicates a frequency of alerts in a simulation period when the risk threshold is set. Here, alerts are issued at a frequency of four times a month. The “detection accuracy” indicates accuracy of an alert when the risk threshold is set. Here, the accuracy of an alert is 75%. The “recommendation rule” indicates a content of the risk threshold. Here, it is recommended to set the CVSS to 8 and the EPSS to 0.7 as the risk thresholds. In other words, the “recommendation rule” indicates that the vulnerability handling for the target product device 10 (product device P1) can be operated so as to satisfy the desired requirements displayed on the simulation condition display area 61 by setting the CVSS to 8 and the EPSS to 0.7 as the risk thresholds.

The alert frequency display area 63 displays a diagram showing a frequency of alerts that occurs when a recommended risk threshold is set in a simulation period. An arrow T in the diagram indicates a direction of time. A start point of the arrow T is the start point of the simulation period. Here, the start point of the arrow T is Jan. 1, 2020. An end point of the arrow T is the end point of the simulation period. Here, the end point of the arrow T is Aug. 1, 2024. An icon I in the diagram indicates a time point when a certain vulnerability is found for the first time within the simulation period and an alert for the vulnerability is issued. Note that although a plurality of icons similar to the icon I are displayed on the alert frequency display area 63, the icons indicate time points at which alerts for different vulnerabilities are issued.

The alert frequency display area 63 allows the user U to visually understand the time and density of a vulnerability alert at the risk threshold.

Note that the user U sets the risk threshold recommended by the operational rule recommendation module 25 in the vulnerability management system 50. Then, the vulnerability management system 50 starts actual vulnerability handling, so that the vulnerability management system 50 can perform an operation similar to the result shown in the simulation result display area 62 in the future.

Next, processing of the vulnerability handling simulation device 20 will be described in more detail.

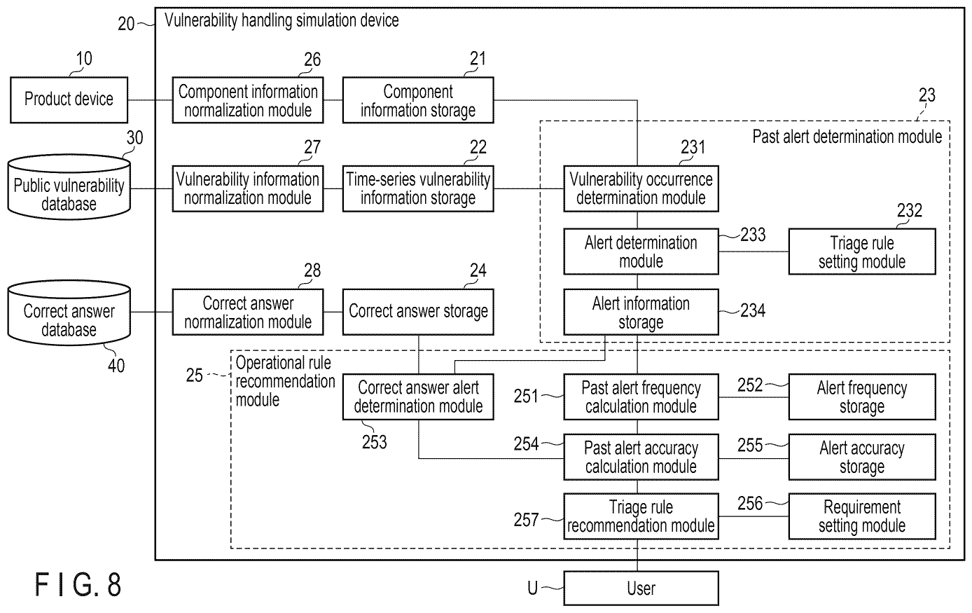

FIG. 8 is a diagram illustrating a detailed configuration example of the vulnerability handling simulation device 20. Note that parts similar to those in FIG. 1 are denoted by the same reference numerals, and detailed description thereof will be omitted.

The vulnerability handling simulation device 20 includes a component information normalization module 26, a vulnerability information normalization module 27, and a correct answer normalization module 28, in addition to the component information storage 21, the time-series vulnerability information storage 22, the past alert determination module 23, the correct answer storage 24, and the operational rule recommendation module 25 illustrated in FIG. 1.

The component information normalization module 26 receives a list of components constituting each product device 10. Hereinafter, the list of components constituting each product device 10 is referred to as “component list information”. The component list information is mechanically output from the product device 10 when the user U operates each product device 10. Alternatively, a part or all of the component list information may be examined by the user U and manually input by the user U via the input device 6 of the vulnerability handling simulation device 20.

The format of the component list information varies depending on each product device 10. Examples of a general format of the component list information include JavaScript (registered trademark) Object Notation (JSON) and eXtensible Markup Language (XML) structured for description of configuration information. Therefore, the component information normalization module 26 recognizes a format of the input component list information, and specifies (parses) and extracts each component included in the component list information. The component information normalization module 26 associates a unique value such as a device name of each product device 10 with each parsed individual component to determine the component of the product device 10, and outputs the component to the component information storage 21.

The component information normalization module 26 also receives an input of a simulation start date for each product device 10. The input of the simulation start date is mechanically output from the product device 10 when the user U operates each product device 10. Alternatively, it may be manually input by the user U via the input device 6 of the vulnerability handling simulation device 20, or a predetermined simulation start date may be automatically input.

Note that the component and the simulation start date of each product device 10 output by the component information normalization module 26 are stored in the component information table 21a of the component information storage 21 described above.

The vulnerability information normalization module 27 periodically acquires vulnerability information disclosed by the external public vulnerability database 30. The vulnerability information normalization module 27 acquires information while changing a parsing method according to a type of the public vulnerability database 30 that provides the vulnerability information. For example, in a case where the public vulnerability database 30 is the NVD, the vulnerability information is disclosed in a JSON format defined in advance by the NVD. Therefore, the vulnerability information normalization module 27 parses the content of the vulnerability information in the public vulnerability database 30 after understanding the JSON format. Furthermore, for example, in a case where the public vulnerability database 30 is another site disclosed in XML, the vulnerability information normalization module 27 parses the content of the vulnerability information in the public vulnerability database 30 after understanding XML.

In addition, the vulnerability information normalization module 27 collects a plurality of pieces of parsed vulnerability information by the date on which the vulnerability information is disclosed, and outputs (stores) the vulnerability information to the time-series vulnerability information storage 22 as a plurality of vulnerability information groups corresponding to the respective dates.

The correct answer normalization module 28 periodically acquires correct answer information disclosed by the external correct answer database 40. The correct answer normalization module 28 acquires the correct answer information while changing a parsing method of the correct answer information depending on a type of the correct answer database 40. For example, in a case where the correct answer database 40 is KEV Catalog of CISA of the United States, a list of correct answer information is provided in the format of the CSV file. Therefore, the correct answer normalization module 28 parses the content of the correct answer information in the public vulnerability database 30 after understanding the format of the CSV file. Note that the content of the correct answer information to be parsed is, for example, a vulnerability number (CVE), a disclosure date, an organization name, and an organization type.

The correct answer normalization module 28 outputs the parsed correct answer information to the correct answer storage 24.

More specifically, the past alert determination module 23 includes, for example, a vulnerability occurrence determination module 231, a triage rule setting module 232, an alert determination module 233, and an alert information storage 234.

The vulnerability occurrence determination module 231 determines whether or not a component constituting the target product device 10 has been vulnerable within a simulation period. Specifically, a plurality of vulnerability information groups stored within the simulation period are sequentially acquired, and it is determined whether or not there is vulnerability information related to the component constituting the target product device 10 among the plurality of pieces of vulnerability information included in the acquired vulnerability information group.

The triage rule setting module 232 initializes risk thresholds to be used in simulation of vulnerability handling, and provides each of a plurality of risk thresholds to the alert determination module 233. In other words, the triage rule setting module 232 drives the alert determination module 233 while changing the risk threshold.

When the vulnerability occurrence determination module 231 determines that a component constituting the target product device 10 is vulnerable, the alert determination module 233 compares a degree of risk of the vulnerability information with a risk threshold provided by the triage rule setting module 232 for each of a plurality of pieces of vulnerability information related to the component. In addition, the alert determination module 233 issues an alert when the degree of risk exceeds the risk threshold for the first time within the simulation period.

The alert information storage 234 stores an alert information table described later. The alert information table is a table for managing a vulnerability number, a date, a degree of risk, a risk threshold, and information indicating whether or not an alert has been issued for a vulnerability for which the degree of risk is equal to or more than the risk threshold.

More specifically, the operational rule recommendation module 25 includes a past alert frequency calculation module 251, an alert frequency storage 252, a correct answer alert determination module 253, a past alert accuracy calculation module 254, an alert accuracy storage 255, a requirement setting module 256, and a triage rule recommendation module 257.

The past alert frequency calculation module 251 calculates an alert frequency with reference to vulnerability information in which an alert is issued by the alert determination module 233. The alert frequency is, for example, an average of the number of alerts generated per month. In other words, the average of the number of alerts is an average number of monthly alerts.

The alert frequency storage 252 stores an alert frequency calculated by the past alert frequency calculation module 251.

The correct answer alert determination module 253 determines whether or not the vulnerability information to which an alert is issued by the alert determination module 233 matches the correct answer information stored in the correct answer storage 24.

The past alert accuracy calculation module 254 calculates accuracy of an alert. Specifically, the past alert accuracy calculation module 254 counts the number of times that the vulnerability information at the issuance of an alert is determined to match correct answer information by the correct answer alert determination module 253. Hereinafter, the counted number is referred to as “the number of correct answers”. the past alert accuracy calculation module 254 calculates an index related to the number of counts of alert issued by the alert determination module 233 and an index related to the number of correct answers. The index related to the number of correct answers is, for example, a matching rate and a coverage.

The alert accuracy storage 255 stores accuracy of an alert calculated by the past alert accuracy calculation module 254.

The requirement setting module 256 acquires a desired requirement input by the user U. The desired requirement is the frequency of the alert and the accuracy of the alert desired (allowable) by the user U.

The triage rule recommendation module 257 recommends, as a risk threshold for issuing an alert related to the vulnerability of the target product device 10, a risk threshold at which the index related to the number of alerts and the index related to the number of correct answers satisfy the alert frequency and the alert accuracy desired by the user U related to vulnerability handling.

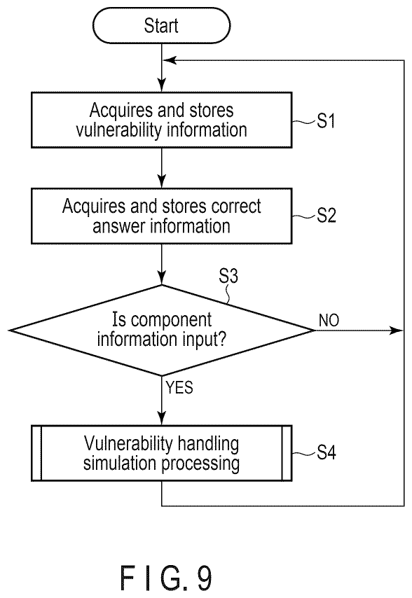

Next, a flow of processing of the vulnerability handling simulation device 20 will be described. FIG. 9 is a flowchart illustrating a flow of entire processing executed by the vulnerability handling simulation device 20.

When the vulnerability handling simulation device 20 is activated, it acquires vulnerability information from the public vulnerability database 30 and stores the acquired vulnerability information in the time-series vulnerability information storage 22 (step S1). Specifically, the vulnerability information normalization module 27 of the vulnerability handling simulation device 20 parses and acquires the vulnerability information disclosed by the public vulnerability database 30, and outputs (stores) the vulnerability information to the time-series vulnerability information storage 22. Note that the vulnerability information normalization module 27 collectively stores the vulnerability information acquired on the same day, as a vulnerability information group, in the public vulnerability database 30.

Similarly, the vulnerability handling simulation device 20 acquires correct answer information from the correct answer database 40 and stores it in the correct answer storage 24 (step S2). Specifically, the correct answer normalization module 28 of the vulnerability handling simulation device 20 parses and acquires the correct answer information disclosed by the correct answer database 40, and outputs (stores) the correct answer information to the correct answer storage 24.

In addition, when a new product device 10 is introduced, the vulnerability handling simulation device 20 detects an input of information of components of the new product device 10 (step S3). Specifically, the vulnerability handling simulation device 20 detects that the component information is stored in the component information storage 21.

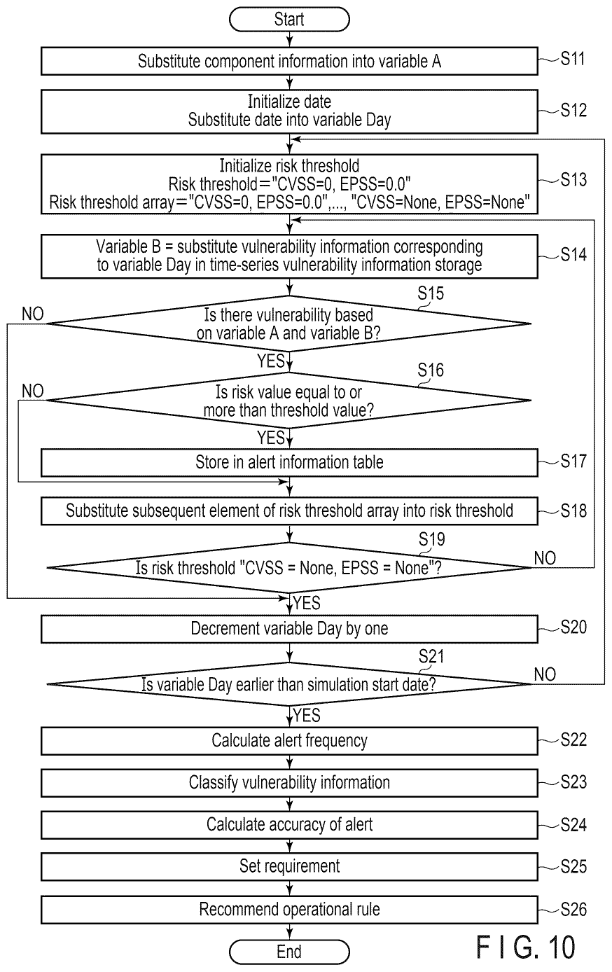

When the information on components of the product device 10 is input (YES at step S3), vulnerability handling simulation processing is performed (step S4). Through the vulnerability handling simulation processing, the vulnerability handling simulation device 20 recommends an appropriate operational rule of vulnerability handling for the target product device 10. Specifically, the vulnerability handling simulation device 20 recommends the risk threshold for the vulnerability handling for the target product device 10. Details of the vulnerability handling simulation processing will be described later with reference to FIG. 10.

When there is no input of component information (NO at step S4), the vulnerability handling simulation device 20 returns to the processing of step S1 and periodically repeats the processing of steps S1 to S4.

By the processing illustrated in FIG. 9, the vulnerability handling simulation device 20 can periodically acquire vulnerability information and correct answer information from the outside and update the vulnerability information group table 22a and the vulnerability information table 22b. In addition, every time a new product device 10 is introduced, the vulnerability handling simulation device 20 can simulate vulnerability handling, thereby recommending an operational rule suitable for the product device 10.

FIG. 10 is a flowchart illustrating an example of a flow of the vulnerability handling simulation processing.

The vulnerability occurrence determination module 231 of the vulnerability handling simulation device 20 substitutes (stores) component information of the product device 10 detected at step S3 of FIG. 9 into a variable A (step S11). The variable A is a read variable. Here, it is assumed that the component information of the product device P1 illustrated in FIG. 6 is detected and the component information (specifically, CPE1, CPE2, and PKG1) of the product device P1 is substituted into the variable A.

In addition, the vulnerability occurrence determination module 231 substitutes (stores) the date on which the vulnerability handling simulation processing has started, into the variable Day (step S12). The date on which the vulnerability handling simulation processing has started is the current date. Here, for example, it is assumed that the current date and time is Oct. 1, 2024. Therefore, “20241001” is substituted for the variable Day.

Next, the triage rule setting module 232 initializes the risk threshold (step S13). As described above, the risk threshold is a risk threshold that is a condition for raising the vulnerability alert during the simulation processing. The risk threshold includes a set of CVSS indicating a degree of severity of vulnerability and EPSS indicating a degree of threat of vulnerability. In the following description, the risk threshold at which the value of CVSS is X and the value of EPSS is Y is referred to as (CVSS=X, EPSS=Y). “Initialize risk threshold” means setting the risk threshold to a head element of a predetermined risk threshold array. The risk threshold array is an array in which a plurality of predetermined risk thresholds are defined. Note that, in the present embodiment, vulnerability handling simulation processing is performed while risk thresholds in the risk threshold array are sequentially selected from the top. In other words, a set of risk thresholds is prepared as a risk threshold array and used for the vulnerability handling simulation processing in order from the top.

The risk threshold array is defined as, for example, “CVSS=0, EPSS=0.0”, “CVSS=0, EPSS=0.1”, “CVSS=0, EPSS=0.2”, “CVSS=0, EPSS=0.3”, “CVSS=0, EPSS=0.4”, “CVSS=0, EPSS=0.5” . . . “CVSS=1, EPSS=0.0”, “CVSS=1, EPSS=0.1”, “CVSS=1, EPSS=0.2”. . . . In this case, after the CVSS is fixed to 0 and the vulnerability handling simulation processing is performed while the EPSS is increased in units of 0.1, the CVSS is fixed to 1 and the vulnerability handling simulation processing is performed while the EPSS is increased in units of 0.1 again.

Note that, in the vulnerability handling simulation processing, it is desirable to reproduce a situation while comprehensively changing a risk threshold (triage rule) for generating an alert. Therefore, the risk threshold (set of CVSS and EPSS) set in the risk threshold array is not limited to the value set to increase in steps of 0.1 as described above. As the risk threshold set in the risk threshold array, for example, a set of CVSS and EPSS that increases in units of an appropriate value (for example, in units of 0.2) is set in consideration of processing speed of the vulnerability handling simulation device 20.

Here, it is assumed that the first element of the risk threshold array is “CVSS=0, EPSS=0.0”, and the last element of the risk threshold array is “CVSS=None, EPSS=None” indicating the end. In addition, the risk threshold array is defined as an array that increases the CVSS in units of 1 and increases the EPSS in units of 0.1 “CVSS=0, EPSS=0.0”, “CVSS=0, EPSS=0.1”, “CVSS=0, EPSS=0.2”, “CVSS=0, EPSS=0.3”,“CVSS=0, EPSS=0.4”, “CVSS=0, EPSS=0.5” . . . “CVSS=1, EPSS=0.0”, “CVSS=1, EPSS=0.1”, “CVSS=1, EPSS=0.2” . . . “CVSS=None, EPSS=None”.

Next, the vulnerability occurrence determination module 231 acquires a vulnerability information group corresponding to the variable Day from the vulnerability information group table 22a of the time-series vulnerability information storage 22, and substitutes (stores) the acquired vulnerability information group into the variable B (step S14). The vulnerability information group corresponding to the variable Day is a plurality of pieces of vulnerability information found on the current date. Here, the vulnerability occurrence determination module 231 acquires, from the vulnerability information group table 22a (see FIG. 4), the vulnerability information group “vulnerability information 20241001” corresponding to the variable Day (20241001), and substitutes the acquired information for the variable B. As illustrated in FIG. 5, the vulnerability information group “vulnerability information 20241001” includes vulnerability information related to vulnerabilities CVE-2018-XXXX, CVE-2021-YYYY, and CVE-2022-ZZZZ.

Then, the vulnerability occurrence determination module 231 compares the variable A with the components of the variable B, and determines whether or not there is a vulnerability (step S15). The variable A contains the configuration information of the product device. The variable B contains the vulnerability information group corresponding to the current date.

Specific examples will be described below. Here, as described above, the components CPE1, CPE2, and PKG1 are substituted into the variable A. In addition, the vulnerability information group “vulnerability information 20241001” is substituted into the variable B.

In this case, the vulnerability occurrence determination module 231 determines whether or not each of the components substituted into the variable A is related to the vulnerability information included in the vulnerability information group of the variable B. For example, the component CPE1 included in the variable A is included in the variable B as a component affected by the vulnerability CVE-2018-XXXX. In addition, the component CPE2 is included in the variable B as a component affected by the vulnerability CVE-2021-YYYY. Therefore, the vulnerability occurrence determination module 231 determines that the product device P1 includes the vulnerability CVE-2018-XXXX and the vulnerability CVE-2021-YYYY.

Note that, in a case where none of the components substituted into the variable A is related to the vulnerability information included in the vulnerability information group of the variable B, the vulnerability occurrence determination module 231 determines that the product device P1 is not vulnerable on the date corresponding to the variable Day.

If it is determined at step S15 that the product device P1 is vulnerable (YES at step S15), the alert determination module 233 determines whether or not the degree of risk of the vulnerability of the product device P1 (vulnerability CVE-2018-XXXX and vulnerability CVE-2021-YYYY) is equal to or more than the risk threshold (step S16). When there are a plurality of vulnerabilities in the product device P1, it is determined whether or not the degree of risk of each of the plurality of vulnerabilities is equal to or more than the risk threshold.

Specifically, the alert determination module 233 recognizes that, for example, the degree of risk of vulnerability CVE-2018-XXXX among the vulnerabilities of the product device P1 is “CVSS=3.5, EPSS=0.9” based on the information of the vulnerability information group substituted into the variable B. Then, the alert determination module 233 compares the degree of risk (CVSS and EPSS) of the vulnerability CVE-2018-XXXX with the risk threshold. Here, it is determined that the degree of risk “CVSS=3.5, EPSS=0.9” of the vulnerability CVE-2018-XXXX is equal to or more than the risk threshold “CVSS=0, EPSS=0.0”.

In addition, the alert determination module 233 recognizes that the degree of risk of the vulnerability CVE-2021-YYYY is “CVSS=9.0, EPSS=0.05”. Then, the alert determination module 233 compares the degree of risk (both CVSS and EPSS) of the vulnerability CVE-2021-YYYY with the risk threshold “CVSS=0, EPSS=0.0”. Here, it is determined that the degree of risk of vulnerability CVE-2021-YYYY is equal to or more than the risk threshold.

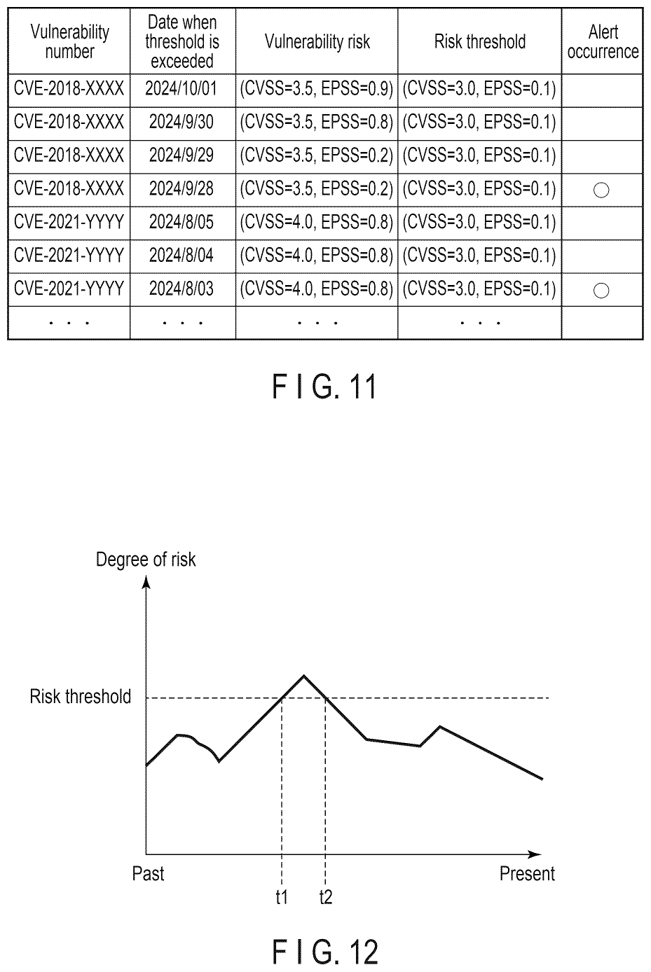

When it is determined at step S16 that the degree of risk of the vulnerability of the product device P1 is equal to or more than the risk threshold (YES at step S16), the alert determination module 233 stores (memorizes) information on the vulnerability in the alert information table (step S17). Specifically, the alert determination module 233 stores, in the alert information table (see FIG. 11) described later, the vulnerability number of the vulnerability for which the degree of risk is determined to be equal to or more than the risk threshold, the value of the variable Day (the date when the degree of risk is equal to or more than the risk threshold), and the degree of risk and the risk threshold of the vulnerability.

On the other hand, when it is determined at step S16 that the degree of risk of the vulnerability of the product device P1 is less than the risk threshold (NO at step S16), the processing proceeds to step S18 without performing the processing of step S17.

Next, the vulnerability occurrence determination module 231 extracts the next element from the risk threshold array and substitutes the extracted element into the risk threshold (step S18).

Then, the vulnerability occurrence determination module 231 determines whether or not the risk threshold is a termination condition (step S19). Here, the termination condition is that the risk threshold is “CVSS=None, EPSS=None”.

When it is determined that the risk threshold is not the termination condition (NO at step S19), the vulnerability handling simulation device 20 repeats the processing of steps S14 to S19 using the risk threshold substituted at step S18. As a result, simulation of vulnerability handling on the same day (the date assigned to the variable Day) is repeated while changing the risk threshold. At the same time, information on the vulnerability of the product device P1 whose degree of risk is determined to be equal to or more than the risk threshold is accumulated in the alert information table on the same day.

On the other hand, when it is determined that the risk threshold is the termination condition (YES at step S19), the vulnerability occurrence determination module 231 determines that the comprehensive vulnerability handling simulation has been completed for the plurality of predefined risk thresholds on the same day. In other words, the vulnerability occurrence determination module 231 determines that the comprehensive vulnerability handling simulation has been completed for all elements of the risk threshold array on the date assigned to the variable Day.

Note that if it is determined at step S15 that the product device P1 is not vulnerable (NO at step S15), it means that the product device P1 is not vulnerable on the date corresponding to the variable Day as described above, and thus the processing proceeds to step S20 without performing the processing of steps S16 to S19.

Next, the vulnerability occurrence determination module 231 decrements the value (the date) substituted into the variable Day by one (step S20). In other words, the vulnerability occurrence determination module 231 substitutes the date of one day earlier into the variable Day.

The vulnerability occurrence determination module 231 determines whether or not the date substituted into the variable Day is a date earlier than the simulation start date of the product device P1 (step S21). The simulation start date of the product device P1 can be recognized by referring to the variable A. The variable A contents the component information of the product device P1. For example, the simulation start date of the product device P1 is 2023 May 5 (see FIG. 3). In this case, the vulnerability occurrence determination module 231 determines whether or not the date indicated by the variable Day is before May 5, 2023. Specifically, the vulnerability occurrence determination module 231 determines whether or not the value indicated by the variable Day is a value smaller than 20230505.

When the date substituted into the variable Day is a date on or after the simulation start date of the product device P1 (NO at step S21), the vulnerability handling simulation device 20 returns to step S13 and repeats the processing of steps S13 to S21. That is, the comprehensive vulnerability handling simulation for the plurality of risk thresholds is repeatedly performed while changing the date until the date is earlier than the simulation start date of the product device P1.

Here, when the vulnerability handling simulation until the simulation start date of the product device P1 ends (YES at step S21), for example, the alert information table as illustrated in FIG. 11 is generated. At this time, for each vulnerability stored in the alert information table, the alert determination module 233 stores, as the date on which a pseudo alert is issued, the date on which the degree of risk of the vulnerability first exceeds the threshold within the simulation period, in the alert information table.

FIG. 11 is a diagram illustrating an example of the alert information table. The alert information table is a table for managing vulnerability information for which the degree of risk is determined to be equal to or more than a risk threshold. The alert information table includes a plurality of entries respectively corresponding to a plurality of vulnerabilities for which the degree of risk is determined to be equal to or more than a risk threshold. Each of the plurality of entries includes, for example, a “vulnerability number” field, a “date” field, a “vulnerability risk” field, a “risk threshold” field, and an “alert occurrence” field. The alert information table is stored in, for example, the alert information storage 234.

In the entry corresponding to a certain vulnerability, the “vulnerability number” field indicates a vulnerability number assigned to the vulnerability.

The “date” field indicates a date when the degree of risk of the vulnerability exceeds a risk threshold. In other words, it indicates the value substituted into the variable Day when it is determined at step S17 that the degree of risk is equal to or more than the risk threshold.

The “vulnerability risk” field indicates the degree of risk when the degree of risk of the vulnerability exceeds a risk threshold.

The “risk threshold” field indicates the risk threshold when the degree of risk of the vulnerability is determined to be equal to or more than a risk threshold.

The “alert occurrence” field indicates whether or not the vulnerability related to the vulnerability information is a vulnerability for which an alert has been issued. For example, “○” is set in the “alert occurrence” field corresponding to the vulnerability for which the alert has been issued, and the “alert occurrence” fields corresponding to other vulnerabilities are set to blanks. The vulnerability for which the alert is issued is a vulnerability for which a risk threshold is exceeded for the first time within the simulation period.

Here, an alert occurrence timing will be described. FIG. 12 is a diagram illustrating a relationship between a degree of risk and time regarding a certain vulnerability. A vertical axis represents the degree of risk, and a horizontal axis represents the time. In addition, a broken line indicates a certain risk threshold.

As illustrated in FIG. 12, in general, a degree of risk of vulnerability varies every day. For this reason, for example, as illustrated in FIG. 12, in a case where the degree of risk shows a mountain shape in which it increases once and then decreases, when it is determined whether or not the vulnerability is dangerous (whether or not to issue an alert) only by the present information, there is a possibility that dangerous vulnerability having a high degree of risk in the past is left as insignificant vulnerability (overlooked). Therefore, as described above, by simulating vulnerability handling based on past vulnerability information, it is possible to understand without fail the vulnerability for which an alert should be issued.

As illustrated in FIG. 12, in a case where a certain degree of risk of vulnerability shows a mountain shape in which it increases once and then decreases, a timing of alert issuance for the vulnerability is usually not the time point t2 at which the degree of risk decreases but the time point t1 at which the degree of risk increases.

Therefore, in the present embodiment, when the risk threshold is exceeded for the first time within the simulation period (that is, when the degree of risk increases), it is defined as a vulnerability for which an alert is issued.

In the example of FIG. 11, the EPSS of the vulnerability CVE-2018-XXXX transitions between 0.9 and 0.2 in the period from 2024 Sep. 27 to 2024 Oct. 1. In addition, the CVSS in the same period is 3.5, which exceeds the risk threshold. In this case, it can be said that the alert regarding the vulnerability CVE-2018-XXXX is actually issued in 2024 Sep. 27 in which the alert is issued for the first time within the simulation period. Therefore, the alert determination module 233 sets “○” in the “alert occurrence” field corresponding to 2024 Sep. 28 as a date and time when a pseudo alert is issued.

Similarly, the vulnerability CVE-2021-YYYY has an EPSS of 0.8 and a CVSS of 4.0, which exceed the risk threshold in the period from 2021 Aug. 03 to 2021 Aug. 5. In this case, it can be said that the alert regarding the vulnerability CVE-2018-XXXX is actually issued in 2021 Aug. 3 in which the alert is issued for the first time within the simulation period. Therefore, the alert determination module 233 sets “○” in the “alert occurrence” field corresponding to 2021 Aug. 3 as a date and time when a pseudo alert is issued.

Next, the past alert frequency calculation module 251 refers to the alert information table and calculates the alert frequency for each risk threshold (step S22). The alert frequency is the number of times an alert is issued for the first time within a simulation period.

Specifically, the past alert frequency calculation module 251 counts the number of vulnerabilities corresponding to the same risk threshold and having a “○” field in the “alert occurrence” field in the alert information table. In other words, the past alert frequency calculation module 251 counts the number of times the alert was issued within the simulation period. In addition, the past alert frequency calculation module 251 counts the number of months in a period from the current date to the simulation start date of the product device P1. Then, the past alert frequency calculation module 251 calculates an average number of monthly alerts by dividing the number of counts of alert issuance by the number of months. The average number of monthly alerts is stored in the alert frequency storage 252. Note that the contents of the alert frequency storage 252 may be browsable by the user U operating the vulnerability handling simulation device 20 as necessary.

In addition, in order to calculate the accuracy of the alert, the correct answer alert determination module 253 determines (classifies), for each risk threshold, the quadrant among four predetermined quadrants in which the vulnerability included in the product device P1 during the vulnerability handling simulation belongs (step S23). In other words, the correct answer alert determination module 253 determines, for each risk threshold, the quadrant among four predetermined quadrants in which the all the vulnerabilities determined to be present in the product device P1 at step S15 during the vulnerability handling simulation belongs.

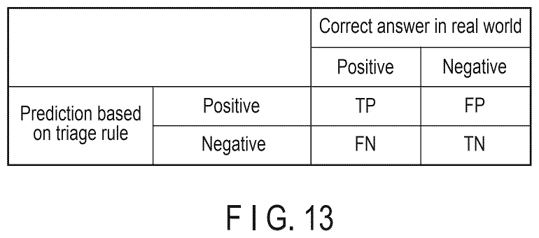

FIG. 13 is a conceptual diagram illustrating four quadrants allocated by the correct answer alert determination module 253.

Here, the “Prediction based on triage rule” means whether or not the vulnerability to be allocated is a vulnerability for which an alert has been issued in the vulnerability handling simulation. In other words, “Prediction based on triage rule” means whether or not the vulnerability to be allocated is included in an alert information table. The “Prediction based on triage rule is Positive” means that the vulnerability is a vulnerability for which an alert has been issued. That is, the vulnerability assigned to “Prediction based on triage rule is Positive” is a vulnerability that has been predicted by the vulnerability handling simulation device 20 to be subject to human review. “Prediction based on triage rule is Negative” means that the vulnerability is a vulnerability for which an alert has not been issued. That is, the vulnerability assigned to “Prediction based on triage rule is Negative” is a vulnerability that has been predicted by the vulnerability handling simulation device 20 not to be subject to human review.

In addition, the “Correct answer in real world” means whether or not a vulnerability to be allocated is disclosed correct answer information. In other words, “Correct answer in real world” means whether or not the vulnerability to be allocated is correct answer information included in the correct answer information table 24a. The “Correct answer in real world is Positive” means that a vulnerability to be allocated is disclosed correct answer information. That is, the vulnerability assigned to the “Correct answer in real world is Positive” means that the vulnerability is a vulnerability that needs to be reviewed by human because it is clear from a third party that an attack is imminent. The “Correct answer in real world is Negative” means that a vulnerability to be allocated is not disclosed correct answer information. That is, the vulnerability assigned to the “Correct answer in real world is Negative” means that the vulnerability is a vulnerability that should not be reviewed by human because the degree of risk is not so high.

As illustrated in FIG. 13, the four predetermined quadrants are the following four.
(1) TP: The prediction based on triage rule is positive and the correct answer in real world is positive

The vulnerability belonging to the TP is a vulnerability for which an alert is issued by the vulnerability handling simulation device 20 and attention is attracted by an authority agency or the like. For example, in a case where vulnerability information in which the alert is issued (vulnerability information stored in the alert information table) matches correct answer information in the correct answer information table 40a, the correct answer alert determination module 253 allocates the vulnerability information to the TP. That is, the number of vulnerabilities allocated to the TP is the “number of correct answers”. Since the vulnerability allocated to the TP is a vulnerability to be handled, it can be said that the cost for human review is rewarded by the occurrence of the alert.
(2) FP: The prediction based on triage rule is positive and the correct answer in real world is negative

The vulnerability information belonging to the FP is a vulnerability for which an alert is issued by the vulnerability handling simulation device 20 but attention is not attracted by an authority agency or the like. For example, in a case where vulnerability information in which the alert is issued (vulnerability information stored in the alert information table) is not included in correct answer information in the correct answer information table 40a, the correct answer alert determination module 253 allocates the vulnerability information to the FP. In the following description, the number of vulnerabilities allocated to the FP is referred to as the “number of incorrect answers”. Since the vulnerability information allocated to the FP is a vulnerability that is regarded as a vulnerability with a low risk among experts, it can be said that the alert has been issued and human review has been performed, but as a result, human review has been wasted.
(3) FN: The prediction based on triage rule is negative and the correct answer in real world is positive

The vulnerability belonging to the FN is a vulnerability for which an alert is not issued by the vulnerability handling simulation device 20 but attention is attracted by an authority agency or the like. For example, in a case where the vulnerability for which the alert has not been issued among the vulnerabilities determined to be included in the product device P1 matches the correct answer information in the correct answer information table 40a, the correct answer alert determination module 253 allocates the vulnerability information to the FN. In the following description, the number of vulnerabilities allocated to the FN is referred to as the “number of times of overlooking”. The vulnerability belonging to the FN can be said to be a case where the vulnerability is actually a vulnerability with a high degree of risk but is left unattended, that is, a case where a high risk vulnerability is overlooked.
(4) TN: The prediction based on triage rule is negative and the correct answer in real world is negative

The vulnerability belonging to the TN is a vulnerability for which an alert is not issued by the vulnerability handling simulation device 20 and attention is not attracted by an authority agency or the like. For example, in a case where the vulnerability information for which the alert has not been issued among the vulnerabilities determined to be included in the product device P1 does not match the correct answer information in the correct answer information table 40a, the correct answer alert determination module 253 allocates the vulnerability information to the TN. In the following description, the number of vulnerabilities allocated to the TN is referred to as the “number of times of being left unattended”. The vulnerability belonging to TN can be said to be a case where a vulnerability having a low degree of risk is correctly left unattended.

Note that the four quadrants in FIG. 13 may be referred to as a confusion matrix.

The past alert accuracy calculation module 254 acquires a result of allocation to the four quadrants from the correct answer alert determination module 253. Then, the past alert accuracy calculation module 254 counts the number of vulnerabilities allocated to each quadrant for each risk threshold, and calculates the accuracy of the alert (step S24).

Here, the accuracy of the alert is, for example, a matching rate and a coverage.

The matching rate can be obtained by the following formula (1). Note that TP is the number of vulnerabilities (the number of correct answers) allocated to the quadrant corresponding to the TP, and FP is the number of vulnerabilities (the number of incorrect answers) allocated to the quadrant corresponding to the FP.

$$Matching rate = TP / ( TP + FP ) \qquad ( 1 )$$

That is, the matching rate is a ratio of the number of correct answers (TP) to the number of times of alerts issued within a simulation period (TP+FP) when the risk threshold is set. The matching rate is an index used when an incorrect answer is not desired to be generated as much as possible. The higher the matching rate, the less the incorrect answer. In the present embodiment, according to the matching rate, it is possible to estimate a ratio of cases in which human has reviewed the vulnerability alert of the product device P1 but it has been actually a low risk and the review has been wasted.

The coverage can be obtained by the following formula (2). Note that FN is the number of vulnerabilities (the number of overlooking) allocated to the quadrant corresponding to the FN.

$$Coverage = TP / ( TP + FN ) \qquad ( 2 )$$

That is, the coverage is a ratio of the number of correct answers (TP) to the number of pieces of correct answer information (TP+FN) related to components constituting the target product device 10 (here, the product device P1) among the correct answer information included in the correct answer information table 24a.

The coverage is an index for evaluating how much the vulnerability to be alerted is covered. The higher the coverage, the higher the coverage rate. In the present embodiment, according to the coverage, it is possible to estimate a ratio of the vulnerability for which an alarm has been issued (covered) to the vulnerability for which an alert should have been issued, in the vulnerability handling of the product device P1.

The past alert accuracy calculation module 254 calculates the matching rate and the coverage, and stores them together with the risk threshold in the alert accuracy storage 255. Note that the contents of the alert accuracy storage 255 may be browsable by the user U performing a predetermined operation for the vulnerability handling simulation device 20.

Next, the requirement setting module 256 acquires a desired requirement set by the user U (step S25). As described above, the desired requirement is the alert frequency and the alert accuracy that the user U considers appropriately when performing the handling vulnerability for the product device P1. For example, the requirement setting module 256 causes the display device 7 to display an alert frequency and alert accuracy input screen and waits for input from the user U, thereby acquiring the desired requirement. The requirement setting module 256 outputs the acquired desired requirement to the triage rule recommendation module 257. Note that the alert accuracy included in the desired requirement may be the matching rate, the coverage, or both the matching rate and the coverage.

Next, the triage rule recommendation module 257 recommends, as an operational rule suitable for the product device P1, a risk threshold satisfying the desired requirement to the user U (step S26). Note that “recommend to the user U” includes, for example, displaying the risk threshold recommendation screen 60 as illustrated in FIG. 7 on the display device 7.

Specifically, the triage rule recommendation module 257 refers to the alert frequency storage 252 and the alert accuracy storage 255 to search for a risk threshold that satisfies the desired requirement. Note that in the search, which one of the alert frequency storage 252 and the alert accuracy storage 255 is prioritized may be determined in advance. For example, when there are a plurality of risk thresholds having the same alert accuracy that satisfies the desired requirement, the risk threshold having a lower alert frequency may be preferentially recommended. In addition, the recommended risk threshold may be plural.

Generally, in performing vulnerability handling, it is beneficial to be able to predict in advance what value the frequency and accuracy (matching rate, coverage) of vulnerability alert will be in consideration of cost and the like. Since there is no correct answer in the frequency and accuracy of the vulnerability alert, when the predicted value is calculated by simulation, the following discussion is expected to be performed in an organization.

For example, when the frequency of the vulnerability alert is high, it is necessary to expand the number of personnel who review the alert in response to the alert. Therefore, it is necessary to secure a budget as an organization for operation in which the alert frequency increases. In addition, the accuracy is an index for evaluating whether the operational quality is good or bad, and it is necessary to review the operational policy depending on the value. For example, if the matching rate is low, that is, if there are many alerts for incorrect answers, there may be a discussion that the number of staff has been increased for review but the budget is wasted. On the other hand, if the security requirement for the product from the customer is high, there may be an operation of continuing the review as much as possible since unnecessary review may be performed. At that time, there is a possibility that the optimum matching rate changes in consideration of balance with the operational cost that can be collected from the customer. Furthermore, the coverage is also similar, and a discussion for determining an optimum value may occur depending on a predicted value by simulation.

After the discussion, what the user U requires is what kind of risk threshold should be set to enable operation that achieves desired alert frequency and accuracy.

In order to solve such a problem, as described above, the vulnerability handling simulation device (information processing device) 20 according to the present embodiment includes: the time-series vulnerability information storage 22 store, at predetermined time intervals, a vulnerability information group including a plurality of pieces of vulnerability information in which a disclosed vulnerability, one or more components related to the vulnerability, and a degree of risk of the vulnerability are associated respectively; the past alert determination module 23 sequentially acquire a plurality of vulnerability information groups stored within a simulation period (within a period designated by the user), and compare the degree of risk with a plurality of predetermined risk thresholds for each of a plurality of pieces of target vulnerability information related to the components constituting the target product device 10 among the plurality of pieces of vulnerability information included in the acquired vulnerability information group, and issue an alert when the degree of risk exceeds a risk threshold for the first time within a designated period; and the operational rule recommendation module 25 aggregate the number of alerts issued within the designated period for each of the plurality of risk thresholds, and recommend, as a risk threshold for issuing an alert related to vulnerability of the target product device 10, a risk threshold at which an index related to the number of alerts satisfies a standard set by the user U.

The human (user U) in an organization simulates the vulnerability handling using the vulnerability handling simulation device 20 according to the present embodiment, thereby being able to understand a risk threshold operable at a desired alert frequency and alert accuracy. As a result, even in a case where a new product device is introduced, it is possible to operate the vulnerability handling with an optimal operational rule based on the desire of the user U for the new product device.

In addition, by, for example, recommending the risk threshold as in the risk threshold recommendation screen 60, the situation of occurrence of the vulnerability alert when the target product device 10 is operated in a simulation period using a plurality of risk thresholds can be understood in time series. In other words, in a combination of a certain risk threshold and the product device 10, the user U can understand the timing at which the human cost is generated by comprehensively indicating a scene requiring human review.

Note that, here, it is described that both the alert frequency and the alert accuracy can be set as a desired requirement, but any one of the alert frequency and the alert accuracy may be set as a desired requirement.

### Second Embodiment

Next, a second embodiment will be described.

As described above, in the simulation processing of the vulnerability handling simulation device 20, in a case where components of the target product device 10 and components of the public vulnerability information completely match, it is detected that the target product device 10 is vulnerable (step S15 in FIG. 10).

Here, the components of the target product device 10 include version information. Since the versions of the components are updated every day, even when compared with the versions of the components currently included in the target product device 10, almost no vulnerability has been found yet, and vulnerability handling may not be accurately simulated.

Therefore, in the second embodiment, a version part of each component is rewound to a certain time point in the past, and then vulnerability handling is simulated. Since the situation of occurrence of the vulnerability regarding the same component does not change suddenly over time, for example, if about one vulnerability per month is found on average in the past 3 years in a certain component, it can be assumed that the vulnerability will be found at a similar frequency in the future.

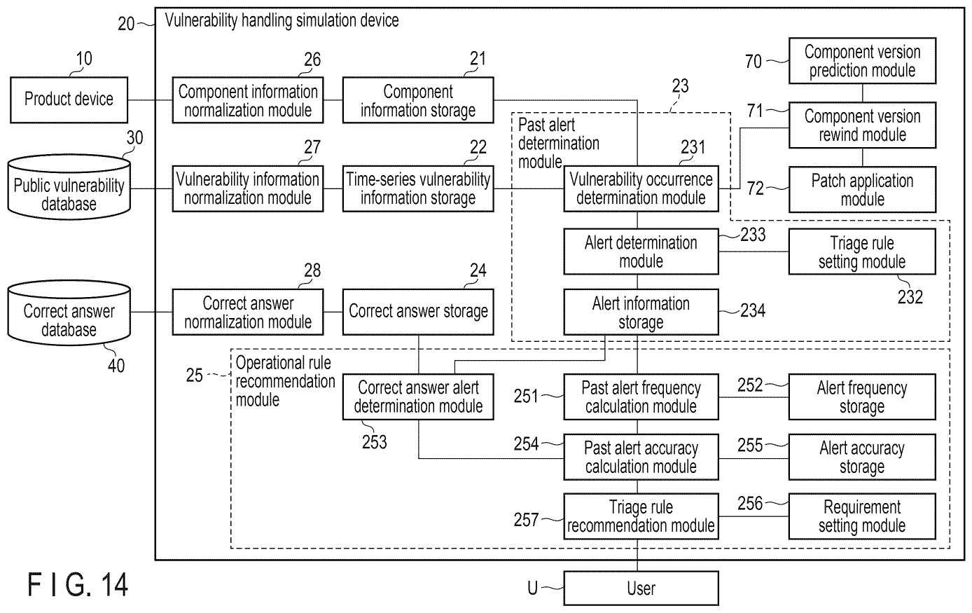

FIG. 14 is a diagram illustrating a configuration example of a vulnerability handling simulation device 20 according to the second embodiment. Note that parts similar to those in the first embodiment are denoted by the same reference numerals, and detailed description thereof will be omitted.

The vulnerability handling simulation device 20 according to the second embodiment includes a component version prediction module 70, a component version rewind module 71, and a patch application module 72 in addition to the configuration of the first embodiment.

Before starting the vulnerability handling simulation processing, the component version prediction module 70 predicts version information near the start point of the simulation period of the component of the target product device 10. The “near the start point of the simulation period” means near the simulation start date.

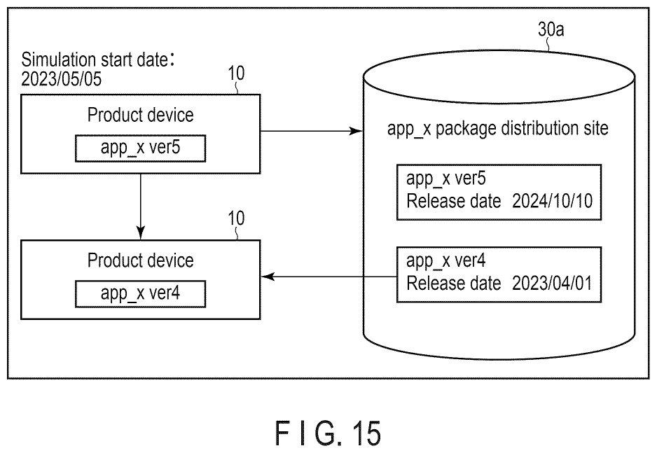

FIG. 15 is a conceptual diagram for explaining prediction of version information by a component version prediction module 70. Here, a case where the past version of the component information of the target product device 10 for which the simulation start date is set to May 5, 2023 is predicted will be described.

For example, “app_x ver5” among components of the target product device 10 will be described. “app_x ver5” is a component described by a package name of a Linux (registered trademark) distribution, and “app_x” indicates a package name and “ver5” indicates a version.

The component version prediction module 70 accesses an external app_x package distribution site (app_x software repository) 30a. In the app_x package distribution site 30a, normally, each version of app_x and information indicating a release date of the version are listed. Hereinafter, information indicating a release date of the version referred to as “version information”. The component version prediction module 70 predicts, as version information of the target product device 10, version information near the simulation start date in the version information. “The version information near the simulation start date” means a version information whose date from the simulation start date to the release date is the closest.

In the example of FIG. 15, the app_x package distribution site 30a lists app_x ver5 released on Oct. 10, 2024 and app_x ver 4 released on Apr. 1, 2023. Among app_x ver5 and app_x ver 4, the component version prediction module 70 predicts, as version information of the target product device 10, app_x ver4 whose release date is closest to May 5, 2023, which is the simulation start date.

The component version rewind module 71 rewrites a version portion of the component of the target product device 10 stored in the component information storage 21, and rewinds the rewritten version portion to the past version.

Thereafter, the vulnerability handling simulation device 20 performs the vulnerability handling simulation processing in the same manner as in the first embodiment. As a result, when it is determined whether or not the target product device 10 is vulnerable, the presence or absence of vulnerability is determined by comparing the component of the past version of the target product device 10 with the disclosed vulnerability information.

The second embodiment is particularly effective when the component of the target product device 10 is the latest version. Of course, regarding the vulnerability of the components of the past version, daily vulnerability information found after release is recorded in the public vulnerability database 30. On the other hand, the number of components in the latest version has not yet been found, and is zero or only a small number that has been found most recently. Therefore, no matter how early the simulation period for the target product device 10 is set in the past, an event in which vulnerability is hardly found occurs.

On the other hand, in the second embodiment, the vulnerability handling simulation processing is performed after predicting the version of the product device on the simulation start date. As a result, even if the component of the target product device 10 is the latest version, it is possible to prevent a situation where the vulnerability is not found and the vulnerability handling cannot be simulated.

Note that although the vulnerability handling simulation processing in the second embodiment is performed under a situation different from the actual configuration of the target product device 10, the nature of each component does not change immediately, so that it is possible to roughly understand the situation of vulnerability handling.

Furthermore, in the above-described processing, a component is predicted and rewritten only once before the vulnerability handling simulation processing is started, but in the middle of the vulnerability handling simulation processing (that is, while steps S13 to S21 of the flowchart of FIG. 10 are performed), a version portion of the component of the target product device 10 stored in the component information storage 21 and a version portion of the component of the target product device 10 substituted for the variable A may be rewritten.

Specifically, the patch application module 72 instructs the component version prediction module 70 and the component version rewind module 71 to predict and rewrite the version of the component of the target product device 10, respectively, at a predetermined timing of patching during the simulation processing. When instructed by the patch application module 72, the component version prediction module 70 predicts, as a component element of the target product device 10, a version released on the day closest to the date substituted in the variable Day. Similarly, the component version rewind module 71 rewrites the version part of the component of the target product device 10 to the version released on the day closest to the date substituted in the variable Day.

The timing of the patch application can be arbitrarily selected by the user U operating the vulnerability handling simulation device 20. As a method of designating the timing of patch application, for example, a regular mode and an irregular mode can be considered.

For example, in a case where the regular mode is set, the patch application module 72 gives an instruction to predict and rewrite the version of the component every time the simulation period elapses a certain time.

For example, in a case where the irregular mode is set, the patch application module 72 instructs to predict and rewrite the version of the component at the date and time within the simulation period designated in advance by the user U. In other words, when the value of the variable Day reaches a date and time designated in advance by the user U, the patch application module 72 instructs to predict and rewrite the version of the component.

In actual vulnerability handling, operation is continued while patches are applied to the components as necessary. Therefore, as described above, by changing the version of the component during the vulnerability handling simulation, the simulation processing can be performed in an environment closer to the actual situation.

According to at least one embodiment described above, it is possible to recommend an operation method of vulnerability handling suitable for each device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. An information processing device comprising:
a time-series vulnerability information storage configured to store vulnerability information groups, each of which is stored at predetermined time intervals and includes a plurality of pieces of vulnerability information, each of the pieces of vulnerability information having a disclosed vulnerability, one or more components related to the vulnerability, and a degree of risk of the vulnerability associated respectively;
a past alert determination module configured to
sequentially acquire the vulnerability information groups stored within a period designated by a user,
compare the degree of risk with predetermined thresholds for each of a plurality of pieces of target vulnerability information related to components constituting a target device among the pieces of vulnerability information included in the acquired vulnerability information groups, and
issue an alert when the degree of risk exceeds the thresholds for the first time within the designated period; and
an operational rule recommendation module configured to
aggregate the number of alerts issued within the designated period for each of the thresholds, and
recommend, as a threshold for issuing an alert related to vulnerability of the target device, one of the thresholds at which an index related to the number of alerts satisfies a standard set by the user.

2. The information processing device according to claim 1, further comprising
a correct answer storage configured to store a plurality of pieces of correct answer information indicating vulnerability that is highly likely to be abused, wherein
the operational rule recommendation module is configured to:
aggregate, for each of the thresholds, a number of correct answers in which target vulnerability information when the alert is issued matches one of the pieces of correct answer information among the number of alerts, and
recommend, as the threshold for issuing an alert related to vulnerability of the target device, one of the thresholds at which at least one of an index related to the number of alerts and an index related to the number of correct answers satisfies the standard set by the user.

3. The information processing device according to claim 2, wherein
the index related to the number of correct answers includes a ratio of the number of correct answers to the number of alerts.

4. The information processing device according to claim 2, wherein
the index related to the number of correct answers includes a ratio of the number of correct answers to the number of correct answer information related to components constituting the target device among the pieces of correct answer information.

5. The information processing device according to claim 1, further comprising:
a component version prediction module configured to predict past version information of the components near a start point of the designated period; and
a component version rewind module configured to rewrite version information included in the components to the past version information.

6. The information processing device according to claim 5, wherein
the component version prediction module is configured to predict the past version information based on a release date at a distribution site of the component of the target device.

7. The information processing device according to claim 5, further comprising
a patch application module configured to instruct the component version prediction module and the component version rewind module on a timing to start processing, wherein
the timing is a predetermined timing during processing by the past alert determination module.

8. The information processing device according to claim 1, wherein
the degree of risk is at least one of CVSS and EPSS.

9. The information processing device according to claim 1, wherein
the period designated by the user is a period from a present date to any past date.

10. A method for execution by an information processing device, comprising:
storing vulnerability information groups in a storage, each of which is stored at predetermined time intervals and includes a plurality of pieces of vulnerability information, each of the pieces of vulnerability information having a disclosed vulnerability, one or more components related to the vulnerability, and a degree of risk of the vulnerability associated respectively;
sequentially acquiring the vulnerability information groups stored within a period designated by a user;
comparing the degree of risk with predetermined thresholds for each of a plurality of pieces of target vulnerability information related to components constituting a target device among the pieces of vulnerability information included in the acquired vulnerability information groups;
issuing an alert when the degree of risk exceeds the thresholds for the first time within the designated period;
aggregating the number of alerts issued within the designated period for each of the thresholds; and
recommending, as a threshold for issuing an alert related to vulnerability of the target device, one of the thresholds at which an index related to the number of alerts satisfies a standard set by the user.

11. A non-transitory computer readable storage medium having stored there on a computer program which is executable by one or more computers, the computer program configured to cause the one or more computers to execute functions of:
storing vulnerability information groups in a storage, each of which is stored at predetermined time intervals and includes a plurality of pieces of vulnerability information, each of the pieces of vulnerability information having a disclosed vulnerability, one or more components related to the vulnerability, and a degree of risk of the vulnerability associated respectively;
sequentially acquiring the vulnerability information groups stored within a period designated by a user;
comparing the degree of risk with predetermined thresholds for each of a plurality of pieces of target vulnerability information related to components constituting a target device among the pieces of vulnerability information included in the acquired vulnerability information groups;
issuing an alert when the degree of risk exceeds the thresholds for the first time within the designated period;
aggregating the number of alerts issued within the designated period for each of the thresholds; and
recommending, as a threshold for issuing an alert related to vulnerability of the target device, one of the thresholds at which an index related to the number of alerts satisfies a standard set by the user.
